(19) United States
(12) Patent Application Publication
(10) Pub. No.: US 2006/0150676 A1
(43) Pub. Date: Jul. 13, 2006

(54) Method for fabricating a porous silica sphere

(76) Inventors: Sun-Uk Kim, Kyungsangbuk-do (KR); Soon-Cheol Hwang, Kyungsangbuk-do (KR); Myong-Cheul Chun, Kyungsangbuk-do (KR)

Correspondence Address: FISH & RICHARDSON PC, P.O. BOX 1022, MINNEAPOLIS, MN, 55440-1022, US

(21) Appl. No.: 10/560,023

(22) PCT Filed: Jun. 10, 2004
(86) PCT No.: PCT/KR04/01380

§ 371 Date: Dec. 8, 2005

(30) Foreign Application Priority Data
Jun. 11, 2003 (KR) 10-2003-0037634

(51) Int. Cl. C03B 8/00; C03B 32/00

(52) U.S. Cl. 65/17.2; 65/29.19

(57) ABSTRACT

The present invention relates to a method for the fabrication of a porous silica sphere, wherein silica gel is treated with heat for a designated time by increasing its temperature at the speed of 90° C. per minute up to 1050 to 1200° C. to fabricate a porous silica sphere. The present invention can fabricate a porous silica sphere that has a homogeneous structure and pore size at a low cost, using commercial silica gel that is sold for various purposes such as food preservation and humidity control, as a raw material.

### BACKGROUND OF THE INVENTION

a) Field of the Invention

The present invention relates to a method for fabricating a porous silica sphere, which can be used for light adiabatic materials that function as heat insulation and for fire resistance, and more specifically, to a method for fabricating a porous silica sphere with a homogeneous porous structure and size so that it can be used in a situation that required heat-insulation and heat-resistance, using a material that costs less.

b) Description of the Related Art

A glass fiber with the diameter of 3 microns has been used as common adiabatic materials and felt or flat board that is made of rock wool or ceramic fiber, has been used as adiabatic materials in case that heat insulation is needed for high temperatures.

Glass fiber or ceramic fiber has many void spaces from fiber to fiber due to their inherent shapes, and these void spaces provide adiabatic effects by preventing the transmission of heat. The principle of using fiber materials as heat-insulation materials by using the void spaces among fibers to cut off heat transmission is the same principle as employed when using a blanket or a thick comforter to insulate warm or cold.

Generally, felt made of glass fiber is used as a heat-insulation material at a temperature ranging from 300° C. to 400° C., while felt made of ceramic fiber is fixed in a location where heat-insulation is required for elevated temperature, or to a flat board made by adding a binder to such heat-resistant materials as ceramic fiber or rock wool mentioned above when it is required of maintain a constant shape. However, the use of these heat-insulation materials has been limited because their features are not satisfactory or their manufacturing costs are too high.

It has long been known that porous silica can be fabricated by making silicon ethoxide directly react with water; gellating while controlling the degree of pH, drying it, and heat-treating it at 1100° C. However, there are many disadvantages that make practical use thereof impossible, as follows: the materials are very expensive; it is hard to make the gel mentioned above into a consistent shape of a sphere to make a porous silica sphere; even if the gel can be shaped into a sphere, it can be easily broken in the process of drying it; and to protect against breakage, such factors as humidity and the amount of drying time need to be regulated, which processes require additional costs (89th Ceramographic Exhibit, W. M. Jones et al.).

However, a manufacturing method to make a silica form was recently developed in which additional reinforcing processes are used, such as to expose it to humid air to absorb some moisture, etc. (Korean Patent Laid-open No. 2001-0106171), while still using some methods similar to existing technologies such as to let water glass react with acid, to add some additional materials thereto, and to remove alkali therefrom etc. to prepare silica gel, which is the same technology as used to manufacture foamy glass. More specifically, this method includes a process to make a predetermined form as an adiabatic material with a predetermined shape by inputting water glass into a mold with a predetermined shape in order to maintain an even thickness, and then sintering at 980° C. to 1300° C. in a tunnel kiln or shuttle kiln.

However, the method mentioned above is inconvenient in that it needs some additional processes other than commonly-known ones, and in addition, some additional materials need to be controlled during the manufacturing process, and the humidity needs to be regulated. Another disadvantage is reported in that when thick form is fabricated, using a mold to foam and shape silica gel at the same time prevents heat from being transmitted to porous silica gel which is present inside, and as a result some silica gel is left not foamed inside the form, which causes an uneven density in the whole form, and accordingly, it is in general difficult to get a desired shape. In addition, this method is only for making porous silica into form with a specific shape. For a broad application toward both a fixed and an indeterminate form of a porous silica sphere, a method is needed to realize fabrication thereof which does not need a fire-resistant mold that must endure the high temperature, in which a porous silica sphere is fabricated homogeneously at first, is used as a heat-insulation filler mixed with other heat-resistant materials, and which can be easily shaped regardless of the desired thickness.

### SUMMARY OF THE INVENTION

In order to solve the problems mentioned above, the aspect of the present invention is to provide a method for fabricating a porous silica sphere with an even porous structure and size, using less expensive materials and a more simple process.

In order to satisfy this aspect, the present invention provides a method for fabricating a porous silica sphere wherein silica gel is subjected to heat-treatment at 1050 to 1200° C. with a temperature increasing speed of less than or equal to 90° C./minute.

### BRIEF DESCRIPTION OF THE DRAWINGS

FIG. 1 is a picture of silica gel made of silicon alkoxide in Comparative Example 1;

FIG. 2 is a picture of porous silica fabricated according to Comparative Example 1;

FIG. 3 is a picture of first grade (5 mesh) silica gel used as a manufacturing raw material of a porous silica sphere in Examples;

FIG. 4 is a picture of fourth grade (12-20 mesh) silica gel used as a manufacturing raw material in Examples;

FIG. 5 is a picture showing the cross section of a porous silica sphere fabricated according to Example 1;

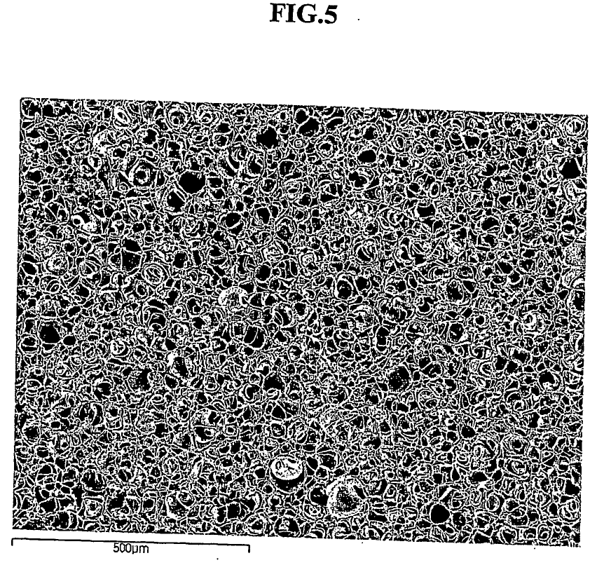

FIG. 6 is a picture of a porous silica sphere fabricated through the heat treatment of first grade silica gel in Example 5;

FIG. 7 is a picture of a porous silica sphere fabricated through the heat treatment of fourth grade silica gel in Example 5; and

FIG. 8 is a picture of a sliced section of a porous silica sphere fabricated through the heat treatment of first grade silica gel in Example 9.

### DETAILED DESCRIPTION OF THE INVENTION

In the present invention, a commercially available dehumidifier silica gel is used without any additional manufacturing process as a main material to fabricate a porous silica sphere that can be controlled in its size, as well as being heat-resistant with a low weight. Of course, a manufactured silica gel can also be used.

The silica gel mentioned above has a pore size of about 20 to 70 angstroms, and the volume of each pore is about 0.3 to 1.0 ml/g. In particular, this gel includes an average of under 2% of interior moisture. The silica gel mentioned above has some impurities, but has purity of over 99% silica.

The silica gel mentioned above can be different depending on each manufacturing company, but in general it is graded into levels when it is sold. For example, it can be sold depending on its size, such as first grade being 5 mesh, second grade being 5-8 mesh, third grade being 8-12 mesh, fourth grade being 12-20 mesh, etc.

A desired porous silica sphere having well-developed pores inside can be fabricated by choosing a silica gel that has the desired size and heat-treating it at a high temperature at a speed of under 90° C. per minute and at 1050° C. to 1200° C., because the commercially available silica gel is already manufactured in a spherical shape.

The average desirable speed of elevating the temperature for the heat treatment of silica gel is under 90° C. per minute, preferably 5° C. per minute to 90° C. per minute, more preferably 5° C. per minute to 80° C. per minute, even more preferably 10° C. per minute to 80° C. per minute, and most preferably 10° C. per minute to 70° C. per minute. The range of the heat treatment lies between 1050° C. to 1200° C., with 1100° C. to 1200° C. being preferred, and 1100° C. to 1150° C. being more preferred.

A porous silica sphere with desirable qualities can be obtained only when the appropriate temperature of the heat treatment and the average speed to elevate the temperature are controlled within the given ranges. If the average speed of elevating the temperature is over 90° C. per minute, it causes a sharp expansion of the moisture inside the subtle pores which brings about the destruction of the porous silica gel, resulting in a failure to form sufficient pores, ultimately causing a failure to form sufficient qualified porous silica spheres. Accordingly, the regulation of the average speed of elevating the temperature plays an important role in fabricating a porous silica sphere. If the average speed of elevating the temperature is lower than 90° C. per minute, the amount of destroyed pieces of silica gel gradually decreases. In general, 80° C. per minute is desirable, and 10° C. per minute to 70° C. per minute is most preferred.

If the temperature of the heat treatment is over 1200° C., silica gel can form some pores during the process, but eventually over-foams due to the extreme elevation of the temperature, which weakens the mechanical strength of a porous silica sphere with extremely-expanded pores, or which also decreases and shrinks the already-foamed pores with the escalation of density and results in lessened heat insulation. If the temperature of the heat treatment is under 1050° C., silica gel cannot form sufficient pores, and the fabricated sphere does not provide satisfactory heat insulation.

The porous silica sphere fabricated through the manufacturing process of the present invention has better heat-insulation than the other porous silica spheres fabricated through other manufacturing processes, because each interior sphere forms ample pores with better isolation from the outside.

According to an advantageous first example of the present invention, a porous silica sphere can be obtained if it is subsequently treated with heat at 1050 to 1200° C. after silica gel is firstly treated with heat at 400 to 900° C. In the process, the speed of temperature elevation is inconsequential since silica gel is not destroyed due to the appropriate removal of the moisture in the silica gel through the first heat treatment even when it is treated with heat at 1050 to 1200° C. after the first heat treatment.

Silica gel quickly emits a great deal of moisture from the normal temperature to about 400° C., and then emits moisture gradually as it approaches 900° C. resulting in that it weighs less. As the temperature increases, silica gel can be destroyed due to the sharp expansion of the moisture inside it. Therefore, if the moisture in the silica gel is removed in the first heat treatment within the above temperature range, and then the second heat treatment is directly performed to the firstly heat-treated silica gel at 1050 to 1200° C., a porous silica sphere with evenly developed pores can be obtained, and it is not destroyed. That is to say, the two stages of heat treatments are necessary to produce an even porous silica sphere efficiently.

According to an advantageous second example of the present invention, an evenly developed silica sphere can be fabricated by using both a rotary furnace and heat treatment. The silica sphere fabricated through this process also has uniform pore structure.

In the prior art, fabrication time is high and the amount of fabrication is limited because there are generally some limits with respect to temperature control, and it is necessary to wait until the furnace is cooled even though an electrical furnace with the capability of quick heating such that subsequent materials can be added to the process is used. The silica gel at or near the surface of the pile of the silica gel in the furnace is relatively well exposed to the heat and also has well-developed pores, but the silica gel inside is relatively less exposed to the heat and has uneven pores even if exposed to the same amount of time and heat. The present invention uses a rotary furnace, through which silica gel runs for heat treatment, as a new method to efficiently produce an even porous silica sphere. The method of the present invention is an improvement over the conventional method in which the silica spheres tend to stick to one another as the time and temperature increase, since the silica gel is heat treated without any rolling in the heat-resistant container.

In the prior art, the method in which silica gel is in situ heat treated in the container from beginning to end results in the fabrication of spheres with internally uneven porous structures. The amount of heat is not even with respect to the upper and the lower parts of the container, which causes the silica gel to have an uneven pore structure formation. In addition, silica gel located in the upper part of the container forms a pore structure and simultaneously plays a main role in heat insulation resulting in making the internal silica gel structure uneven. However, the use of a rotary furnace as in the present invention evenly exposes the silica gel to the heat, and also makes it possible to fabricate a silica sphere with an even porous structure.

According to an advantageous third example, more than two separate rotary tube furnaces with electric heating systems are used. Silica gel is treated with a first heat treatment in the first rotary tube, and is subsequently sent to the second rotary tube to be treated with a second heat treatment at a predetermined temperature for a predetermined amount of time to produce an even porous silica sphere. The first heat-treatment temperature is 400 to 900° C., more preferably 600 to 800° C., and most preferably 700° C. The amount of time that the silica gel is heat treated in the furnace can be regulated by controlling the rotating speed of the furnace. The amount of time to attain an appropriate temperature of the furnace can be regarded as half the amount of the total time, and for the rest of the time the temperature is consistent. Therefore, the elevation speed of the temperature in the first heat treatment can be calculated as half the total amount of time it takes to heat the silica gel with heat. For example, if it takes 20 minutes to treat silica gel with a heat of 700° C., half that time (10 minutes) is used to bring the temperature to the appropriate level and half that time (10 minutes) is spent to keep the temperature consistent. The average speed of elevating the heat-treatment temperature in the process of elevating the temperature to 700° C. can also be calculated as follows: 700° C./(20/2)=70° C./minute.

The length of the tube used here is not particularly significant. If it is longer, the amount of time to pass through tube can be regulated with a higher speed of rotation, and if shorter, the speed of rotation can be lowered.

The average speed of elevating temperature in the first heat treatment is not crucial, but 5 to 90° C./minute is preferable, and 20 to 40° C./minute is more preferable. As to the temperature of the rotary tube in the second heat treatment, 1050 to 1200° C. is preferable, and 1100 to 1150° C. is more preferable. As to the amount of time in the first heat treatment, 20 minutes to 60 minutes is preferable and 20 minutes to 40 minutes is more preferable, while for the second heat treatment, 20 minutes to 60 minutes is preferable and 20 minutes to 40 minutes is more preferable. A silica sphere with well-developed pores is produced when silica gel gets heat treatment within the aforementioned temperature ranges.

According to the fourth advantageous example of the present invention, a silica sphere with desired pores can be fabricated by elevating the temperature by 35° C./minute to 70° C./minute in the first tube furnace to 700° C., maintaining the temperature for 10 to 20 minutes, performing the second heat treatment at 1100 to 1200° C., and keeping it in the second tube furnace for 20 to 60 minutes, more preferably for 20 minutes.

Controlling the temperature in the second tube regulates the degree of pore formation by preventing the silica gel from over-foaming and under-foaming.

As mentioned above, the regulation of temperature distribution in one tube can achieve the same effect as when two furnaces for heat treatment are used.

A porous silica sphere fabricated according to the present invention has many pores with a diameter of about 100 microns, and each silica sphere has an internal structure like a sponge and individual silica spheres form exclusive pores isolated from the outside.

The apparent filling density of a porous silica sphere can differ depending on the silica gel used in the process, but it ranges from about 0.18 to 0.30 g/ml. If relatively large silica gel is used, a silica sphere with a lesser surface area compared to its weight is obtained, while if small silica gel of the same amount is used, a silica sphere with a high density due to more glass on the surface than at the internal pores is obtained.

The following examples are to provide greater understanding of the present invention, but they are not to be construed as limiting the present invention thereto.

### COMPARATIVE EXAMPLE 1

5N hydrochloric acid (2 ml) were added to Silicon ethoxide (100 ml) and stirred with the addition of distilled water (250 ml). After stirring for 30 minutes, 1N ammonium hydroxide (15 ml) was added to the resulting mixture, and was gradually gellated. The gel was then dried for 24 hours in a drying oven. The dried pieces of silica gel were placed in an electric furnace for 30 minutes with the temperature increasing to 1100° C. at a speed of 5° C. per minute.

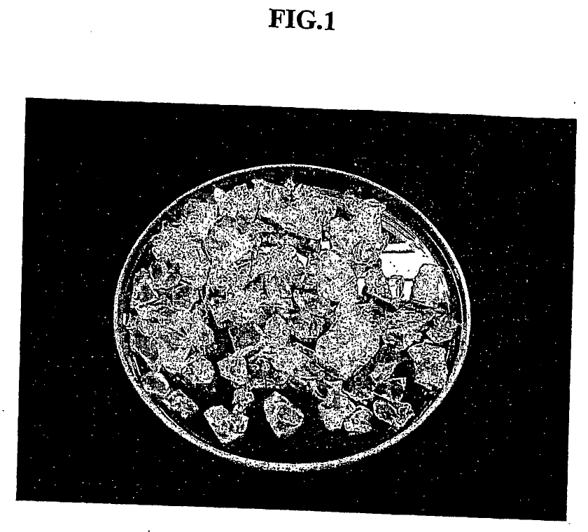

The dried silica gel had a cracked shape with a sharp surface like pieces of broken glass, as shown in FIG. 1.

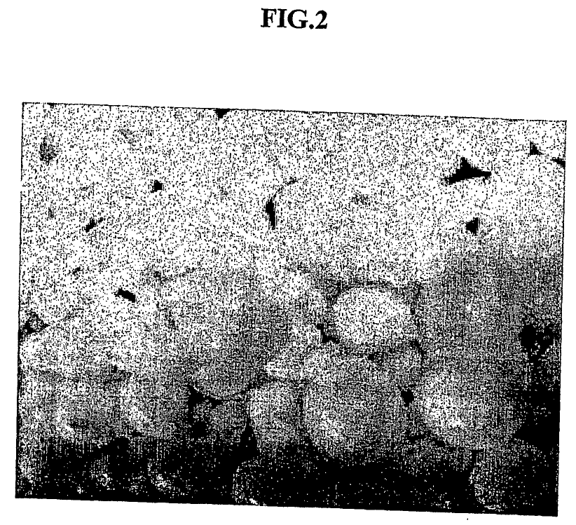

Since the alkoxide gel was cracked continuously into pieces and foamed during heat treatment, it is difficult to control the shape and size of the fabricated porous silica, such that most of the heat-treated silica has a non-spherical shape as shown in FIG. 2.

The silica gel in Example 1 has an irregular shape and size. Although there is a way to control the size of particles and to make spheres by using this material, it is hard to use it economically since it is very expensive compared to using commercial silica gel as a raw material.

### COMPARATIVE EXAMPLE 2

5N hydrochloric acid (2 ml) were added to silicon ethoxide (100 ml) and stirred with the addition of distilled water (250 ml). After stirring for 30 minutes, 1N ammonium hydroxide (15 ml) was added to the resulting mixture, and it was gradually gellated. The gel was then dried for 24 hours in a drying oven. The dried pieces of silica gel were placed in an electric furnace for 1 hour with the temperature increasing to 1200° C. at a speed of 5° C. per minute.

The results were similar to Example 1, and the shape of porous silica was also similar to that of FIG. 2. As shown in FIG. 2, it contained many non-spherical shapes.

### COMPARATIVE EXAMPLE 3

Silica was fabricated according to the same manner as in Example 1, except the amount of distilled water was reduced from 250 ml to 100 ml. The porous silica obtained thereby was similar to Comparative Example 1.

### COMPARATIVE EXAMPLE 4

First grade (5 mesh; diameter: 3-4 mm) and fourth grade (12-20 mesh; diameter: 0.84-1.68 mm) commercialized silica gel (of Tong Yang Chemical Inc.) were placed in an electric furnace for 1 hour with the temperature increasing to 1000° C. at a speed of 5° C. per minute.

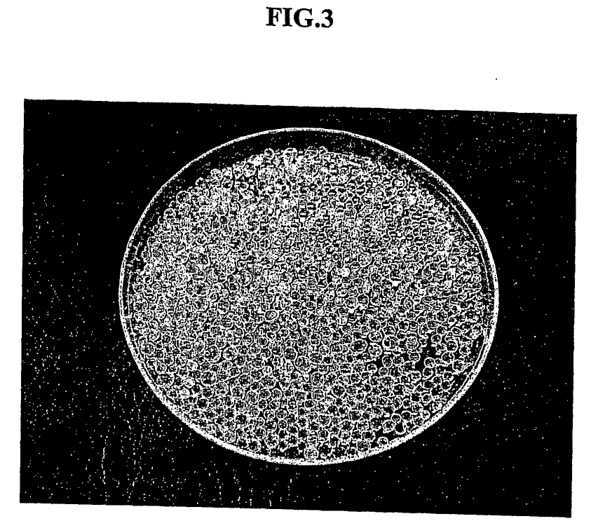

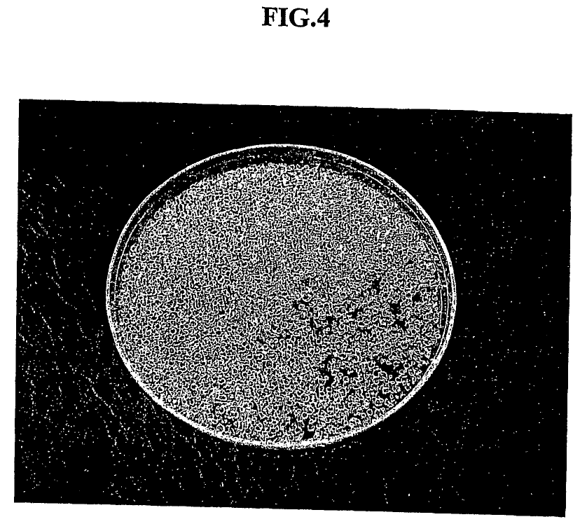

FIGS. 3 and 4 show pictures of the first grade and fourth grade silica gel that were used as raw materials. The degree of foaming was measured by observation of expanding volume and microscopic structure, and this silica gel can be seen as being foamed in the initial state such that foaming occurred only internally but the external volume did not increase.

### COMPARATIVE EXAMPLE 5

Commercial silica gel (of Tong Yang Chemical Inc.) was treated with heat by directly putting it into an electric rotary tube furnace, which increased the temperature at an average speed of 300° C. per minute up to 1100° C., without a pre-heating process. In this case, most of the silica gel was destroyed by heat-shock, and while some of the destroyed pieces were foamed into porous structures, most of them did not. Thus, rapid heat-treatment was not appropriate.

### EXAMPLE 1

Commercial silica gel (of Tong Yang Chemical Inc.) was treated with heat by putting it into an electric rotary tube furnace for 1 hour, and increasing the temperature at an average speed of 5° C. per minute up to 1100° C. All the silica gel foamed and formed porous silica spheres with a sponge style of porous structure. FIG. 3 illustrates a cross section of a porous silica sphere that was obtained in the process. As shown in FIG. 3, the homogeneous development of the porous structure in a porous silica sphere was confirmed.

### EXAMPLE 2

Commercial silica gel (of Tong Yang Chemical Inc.) was heat treated in the same manner as in Example 1, except that the commercial silica gel was put into an electric rotary tube furnace and the temperature was increased at the average speed of 10° C. per minute up to 1150° C. and maintained for 1 hour. The fabricated porous silica sphere was similar to that of Example 1.

### EXAMPLE 3

Commercial silica gel (of Tong Yang Chemical Inc.) was heat treated in the same manner as in Example 1, except that the commercial silica gel was put into an electric rotary tube furnace and the temperature was increased at the average speed of 10° C. per minute up to 1050° C. and maintained for 1 hour. In this example, although it contained some non-foamed silica gel, the result was similar to Example 1 such that most was foamed and formed porous silica spheres.

### EXAMPLE 4

In the present example, commercial silica gel (of Tong Yang Chemical Inc.) was treated with heat using two separate electric rotary tube furnaces.

It was firstly treated with heat in a rotary tube furnace by increasing the temperature at the speed of 40° C. per minute for 10 minutes up to 400° C. and maintaining it for 10 minutes resulting in total first heat-treatment for 20 minutes. Subsequently, it was put into a second rotary tube furnace that was maintained at 1100° C., left for 20 minutes, and recovered. As a result, although it contained a small amount of silica gel that was not foamed and was destroyed, the rest foamed and formed porous silica spheres.

### EXAMPLE 5

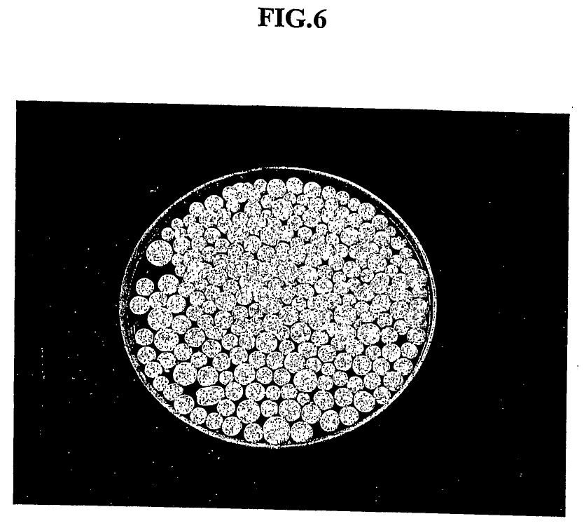

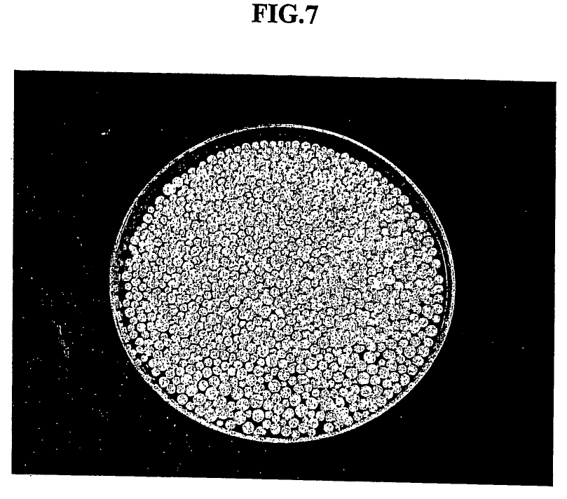

Commercial silica gel (of Tong Yang Chemical Inc.) was treated with heat in a first rotary tube furnace for a total of 20 minutes by increasing the temperature at the speed of 70° C. per minute for 10 minutes up to 700° C. and maintaining it for 10 minutes. Subsequently, it was put into a second rotary tube furnace that was maintained at 1100° C. and heat-treated for 20 minutes. As a result, most of the commercial silica gel was sufficiently foamed and formed porous silica spheres. FIG. 6 illustrates fabricated porous silica spheres that were made of the first grade silica gel, and FIG. 7 illustrates the porous silica spheres that were made of the fourth grade silica gel.

### EXAMPLE 6

Porous silica spheres were fabricated in the same manner as in Example 5, except that the second heat treatment was performed for 60 minutes at 1100° C. in the second tube furnace. The result was similar to that of Example 5.

### EXAMPLE 7

Commercial silica gel (of Tong Yang Chemical Inc.) was heat treated in the same manner as in Example 5, except that the second heat treatment was preformed for 20 minutes at 1120° C. in the second tube furnace. The result was similar to that of Example 5, producing similar porous silica spheres.

### EXAMPLE 8

Porous silica spheres were fabricated in the same manner as in Example 5, except that the second heat treatment was preformed for 20 minutes in the second tube furnace maintained at 1150° C. The result was similar to that of Example 5.

### EXAMPLE 9

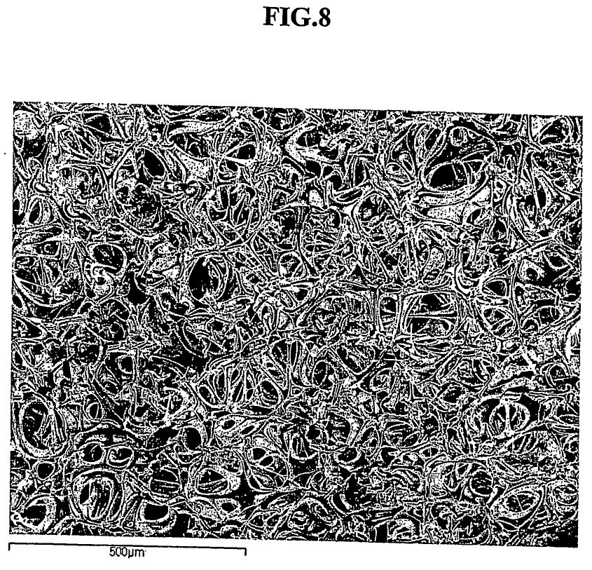

Porous silica spheres were fabricated in the same manner as in Example 5, except that the second heat treatment was performed for 20 minutes in the second tube furnace maintained at 1200° C. As a result, although the size of pores in a part of the porous silica spheres was larger than those in FIG. 3, as shown in FIG. 8, most of them were similar to Example 3 in terms of shape and size. Therefore, it is not advantageous to treat with heat over 1200° C. since it causes an increase in the amount of over-foaming silica.

### EXAMPLE 10

Commercial silica gel (of Tong Yang Chemical Inc.) was treated with heat in a first rotary tube furnace for a total of 40 minutes, by increasing the temperature at the speed of 35° C. per minute for 20 minutes up to 700° C., and maintaining it for 20, minutes. Subsequently, it was put into a second rotary tube furnace that was maintained at 1100° C. and kept for 20 minutes. As a result, a fabricated porous silica sphere that was similar to Example 5 was produced.

### EXAMPLE 11

Commercial silica gel (of Tong Yang Chemical Inc.) was treated with heat in the same manner as in Example 5, except that it was treated with heat in the first rotary tube furnace for a total of 20 minutes by increasing the temperature at a speed of 90° C. per minute for 10 minutes up to 900° C. and maintaining it for 10 minutes. As a result, although a small amount of the resultant was partly destroyed and formed porosity insufficiently, it mostly formed porous silica spheres like in Example 5.

### EXAMPLE 12

Commercial silica gel (of Tong Yang Chemical Inc.) was treated with heat in the same manner as in Example 5, except that it was treated with heat in the first rotary tube furnace for a total of 40 minutes by increasing the temperature at the speed of 40° C. per minute for 20 minutes up to 800° C. and maintaining it for 20 minutes. As a result of changing the time for the first heat treatment, the amount of cracks formed and silica destroyed was remarkably reduced, and the result was similar to that of Example 5.

### EXAMPLE 13

Commercial silica gel (of Tong Yang Chemical Inc.) was treated with heat in a first rotary tube furnace for a total of 40 minutes by increasing the temperature by the speed of 35° C. per minute for 20 minutes up to 700° C. and maintaining it for 20 minutes. After that, it was put into a second rotary tube furnace that was maintained at 1100° C. and kept for 40 minutes. The result was similar to that of Example 5.

As mentioned above, a porous silica sphere that can be used in various ways can be fabricated by using commercial silica gel and treating it at the proper temperature, without using an expensive raw material or needing a complex and high-cost facility to make a uniform shape. Crack formation that occurrs when silica gel is intended to be prepared using silicon alkoxide or water glass is also prevented during the process of gellation and dehydration, the complicated procedure of using additional additives is not needed, and moisture is absorbed adequately. In this invention, a large quantity of porous silica spheres can be easily fabricated through pre-heat treatment in a short time.

As described above, the present invention shows that a porous silica sphere that can be used as a light adiabatic material can be fabricated through heat-treating a commercially available silica gel and without using high-cost raw materials and undergoing a separate process to fabricate porous silica. Therefore, a porous silica sphere that has an adiabatic effect and is light weight can be fabricated through an established heat treatment process without going through a separate and complex fabricating process.

What is claimed is:

1. A method for fabricating a porous silica sphere comprising:
heat-treating a silica gel by increasing its temperature at a speed of less than 90° C. per minute up to 1050 or 1200° C.; and
maintaining the temperature for a predetermined time.

2. The method of claim 1, wherein the silica gel has pores with a size of about 20 to 70 angstroms, and a pore volume of around 0.3 to 1.1 ml/g.

3. The method of claim 1, wherein the heat-treatment is performed at an average temperature elevating speed ranging from 5° C. to 90° C. per minute.

4. The method of claim 1, wherein the heat-treatment is performed at an average temperature elevating speed ranging from 10° C. to 70° C. per minute.

5. The method of claim 1, wherein heat treatment is performed in a rotary tube furnace.

6. A method for fabricating a porous silica sphere comprising a heat treatment process, wherein silica gel is subjected to a first heat-treatment at 400 to 900° C., and is subjected to a second heat-treatment at 1050 to 1200° C.

7. The method of claim 6, wherein the first heat treatment is performed for 20 to 60 minutes, and the second heat treatment is performed for 20 to 60 minutes.

8. The method of claim 6, wherein the heat treatment is performed using at least two rotary tube furnaces.

9. The method of claim 6, which comprises putting the silica gel into a first tube furnace;
subjecting it to a first heat-treatment by increasing the temperature at an average speed of 35 to 70° C. per minute up to 700° C., and then maintaining it for 10 to 20 minutes; and
subjecting it to a second heat-treatment in the second tube furnace at 1100 to 1150° C., then maintaining it for 20 to 60 minutes.
